(19) United States
(12) Patent Application Publication
(10) Pub. No.: US 2022/0111556 A1
(43) Pub. Date: Apr. 14, 2022

(54) INTERLOCKING BLOCK MOLDS

(71) Applicant: WILLIAM DONNELLY, BARRINGTON, NH (US)

(72) Inventor: WILLIAM DONNELLY, BARRINGTON, NH (US)

(21) Appl. No.: 17/067,619

(22) Filed: Oct. 9, 2020

(51) Int. Cl. B28B 7/26; B28B 7/00

(52) U.S. Cl. CPC B28B 7/26; B28B 7/0014

(57) ABSTRACT

This disclosure provides interlocking blocks molds that can be connected on any side to form an interlocking block mold, interlocking block, structure, wall, foundation, floor, building, flotation device, gardening structure, artificial coral reefs, or toy. The interlocking blocks molds typically comprise center outward protrusions and connecting outward protrusions on each side and can be connected with hardware through the connecting outward protrusions or with a connection coupling on the exterior of the outward protrusions. The center outward protrusions allow for materials such as pipes, wires, conduit, and rebar to pass through interlocked block molds. Connected block molds can also be filled with fortifying material to strengthen the structure. Sides of connected block molds exterior protrusions can be covered with faceplates to direct flow of fortifying material and aid in the creation of desired configurations. Also provided are connection couplings for connecting sides of the interlocking blocks molds.

### PRIORITY

This application claims priority to U.S. Provisional Application No. 62/912,979, filed Oct. 9, 2019 and titled “Interlocking Blocks molds,” and this application also claims priority to U.S. Non-Provisional application Ser. No. 16/155,990—Docket No. DON.100UTI, filed Oct. 10, 2018, and International Application No. PCT/US18/55139—Docket No. DON.100PCT, filed: Oct. 10, 2018, and titled “Interlocking Blocks,” and this application also claims priority to U.S. Provisional Application No. 62/577,917, filed Oct. 27, 2017 and titled “Interlocking Rectangular Prism Blocks Connecting Building Structures” and to U.S. Provisional Application No. 62/577,633, filed Oct. 26, 2017 and titled “Interlocking Trapezoidal Prism Blocks Connecting Building Structures,” all of which applications are incorporated herein by reference in their entireties.

### FIELD

This disclosure relates to interlocking block molds. More specifically, this disclosure relates to interlocking block molds for manufacturing interlocking blocks for use in construction, flotation, and a variety of other uses.

### BACKGROUND

Presently, interlocking block molds do not have the capability to be locked together from the top, bottom, and all sides, along with being able to pass rebar, pipes, conduit and other materials through the bodies of all the molds as they are interlocked together. Further, existing interlocking block molds are unable to manufacture interlocking blocks that connect to either side of another interlocking block or to either side of another interlocking block mold.

Current interlocking block molds lack the ability to manufacture an interlocking block that can provide sufficient strength and height to prevent rising sea waters from breaching the walls. With waters continuing to rise, governments and municipalities around the world need to reinforce existing walls, build new walls, and engineer additional solutions to prevent incoming water from destroying waterfront structures and localities.

A major drawback of existing wall systems requiring interlocking block molds to manufacture the interlocking blocks to be used in constructing the existing wall system, is the existing interlocking block molds inability to produce interlocking blocks that can be joined together on all sides by additional interlocking blocks, or the inability of current interlocking block molds to produce interlocking blocks that can be joined together on all sides by additional interlocking block molds by using mechanical hardware or connected together with coupling connectors to the exterior ends of interlocking block molds outward protrusions. A second major drawback of current interlocking block molds and wall systems is the inability to produce interlocking block molds that can pass materials such as rebar, pipes, wire, conduit, etc. through the interlocking block molds in different directions. A third major drawback of existing interlocking block molds and wall systems is the inability to manufacture interlocking block molds that can be filled with strengthening materials to form one continuous and solid structure with all connected interlocking block molds.

A need exists for improved interlocking block molds that can produce interlocking blocks for retaining walls, sea walls, foundations, buildings, artificial reefs, and other applications.

### SUMMARY

In one aspect, this disclosure provides interlocking block molds capable to manufacture interlocking blocks, comprising at least three parallelogram sides, wherein each side comprises a side center outward protrusion around the center of the side, four side corners, at least one side interlocking outward protrusion proximate to each side corner; and two ends. In some embodiments, an interlocking block mold which comprises a plurality of side interlocking outward protrusions proximate to each side corner is used to manufacture an interlocking block. In further embodiments, an interlocking block mold which comprises four side edges and one or more side edge outward protrusions proximate to one or more of the side edges is used to manufacture an interlocking block.

Yet another aspect of this disclosure is directed to interlocking block molds manufacturing interlocking blocks that produces an interlocking block structure, comprising a plurality of interlocking block molds and interlocking blocks, wherein each interlocking block mold comprises five or more sides, and wherein each side comprises a center outward protrusion and a plurality of connecting outward protrusions, wherein the plurality of interlocking block molds are connected by hardware through the connecting outward protrusions, and wherein a plurality of the center outward protrusions are aligned.

In some embodiments, the interlocking block molds used in the manufacturing interlocking blocks produces an interlocking block mold structure connecting interlocking block and interlocking block molds whereas the interlocking block molds structure may be filled with a material or a combination of materials.

### BRIEF DESCRIPTION OF THE FIGURES

FIG. 1 depicts a three-dimensional view of an embodiment of an interlocking block mold.

FIG. 2 depicts a three-dimensional view of an embodiment of an interlocking block mold.

FIG. 3A depicts a side view of hardware aligned with connecting openings of aligned interlocking block molds.

FIG. 3B shows a cutout view of two aligned interlocking block molds without hardware.

FIG. 4 depicts the interior hollow portions of six interlocking block molds being filled with cement.

FIG. 5 depicts six interlocking block molds connected together in an exemplary configuration.

FIG. 6 depicts an interlocking block with a faceplate covering one side of the interlocking block mold.

FIG. 7 depicts shows a plurality of interlocking block molds connected together in an exemplary configuration.

FIG. 8 depicts shows a plurality of interlocking block molds connected together in an exemplary configuration.

FIG. 9 depicts a side view of a side of an interlocking block mold.

FIG. 10 depicts an exemplary structure comprised of interlocking block molds with some interlocking block molds having faceplates attached.

FIG. 11 depicts an exemplary configuration of interlocked block molds with faceplates attached to one side.

FIG. 12 depicts an exemplary configuration of interlocked block molds with faceplates attached to one side.

FIG. 13A depicts an embodiment of an interlocking block mold.

FIG. 13B shows an enclosed view of an interlocking block mold placed inside a transparent box to allow an interlocking block to be molded.

### DETAILED DESCRIPTION

This disclosure provides interlocking block molds that can be made of a variety of materials and have a variety of applications. More specifically, this disclosure provides interlocking block molds that can be connected together mechanically on each side of an interlocking block mold.

As used herein, the term “and/or” includes any and all combinations of one or more of the associated items. As used herein, the terms “a”, “an”, and “the” mean one or more, unless contextually or specifically indicated otherwise. As used herein, the term “about” means+/−10% of a stated value.

As the climate on the Earth continues to change and sea levels continue to rise, stronger and higher retaining walls and seawalls are needed to protect coastal communities. The interlocking block molds to manufacture interlocking blocks of this disclosure can be used to build stronger and taller retaining walls and seawalls that are filled with fortifying materials, and to produce interlocking block and Interlocking block mold structures that can allow a foundation for earth and vegetation to produce salt marshes and mangroves, watersheds and drainage basins, and gardens for indigenous plants, eatable plants, and animals to thrive. The design of the interlocking block molds to manufacture interlocking blocks also allows for objects to be passed through the interlocking block molds prior to filling them with material. For example, metal pipe, plastic pipe, wires, conduit, rebar, insulation, and other materials can be passed through the center outward protrusions of connected interlocking block molds prior to filling the structure with fortifying material. Walls created with interlocking blocks manufactured with the aforementioned interlocking block molds of this disclosure are unlike any other walls in previous existence.

This disclosure provides interlocking block molds to manufacture interlocking blocks and structures. Each interlocking block mold has a number of sides that are parallelograms and two identical ends. Unlike existing interlocking block molds systems, any side of the interlocking block molds of this disclosure can be connected to another interlocking block mold. In other words, the interlocking block molds of this disclosure can be connected on any end or side of an interlocking block mold. In some embodiments, the interlocking block mold has three parallelogram sides with outward protrusions (referred to herein as “triangular”) and two ends. In other embodiments, the interlocking block mold has four parallelogram sides with outward protrusions (referred to as “rectangular”) and two ends. In further embodiments, the interlocking block mold has five parallelogram sides with outward protrusions (referred to as “pentagonal”) and two ends. In additional embodiments, the interlocking block mold has six parallelogram sides with outward protrusions (referred to as “hexagonal”) and two ends. In still further embodiments, the interlocking block mold has more than six parallelogram sides and has two ends.

Each parallelogram side of an interlocking block mold comprises four corners and four edges. One or more sides and/or ends of an interlocking block mold comprise a center outward protrusion around its center. In some embodiments, the ends of an interlocking block mold comprise three or more corners and three or more edges. In some embodiments, one end or both ends of an interlocking block mold comprise a center outward protrusion around its center. In some embodiments, each center outward protrusion on a side aligns with the center outward protrusion on the opposite side. In some embodiments, one or more connecting outward protrusions are located proximate to each corner of each side. In some embodiments, one or more edge connecting outward protrusions are located proximate to the middle of one or more edges of the sides. The orientation and location of the connecting outward protrusions and edge outward protrusions varies. In some embodiments, the center outward protrusion, connecting outward protrusion, or edge outward protrusion is round. In other embodiments, the center outward protrusion, connecting outward protrusion, or edge outward protrusion is not round. As used herein, the term “connecting outward protrusion” can refer to either a connecting outward protrusion proximate to a corner on a side of an interlocking block mold or an edge outward protrusion proximate to an edge of a side of an interlocking block mold or both.

In some embodiments, all of the sides and ends of an interlocking block mold comprise a center outward protrusion. In other embodiments, all of the sides and ends of an interlocking block mold comprise a center outward protrusion and one or more connecting outward protrusions. In further embodiments, some sides and/or some ends have center outward protrusions, or connecting outward protrusions, or both. In some embodiments, one side or one end of the interlocking block molds has no center outward protrusion and no connecting outward protrusions. In other embodiments, two sides of the interlocking block molds have no center outward protrusion and no connecting outward protrusions. In further embodiments, one side and one end of the interlocking block molds have no center outward protrusion and no connecting outward protrusions. In still further embodiments, three sides of the interlocking block molds have no center outward protrusion and no connecting outward protrusions. In yet further embodiments, one side and two ends of the interlocking block molds have no center outward protrusion and no connecting outward protrusions. In additional embodiments, two sides and one end of the interlocking block molds have no center outward protrusion and no connecting outward protrusions. In some embodiments, four sides of the interlocking block molds have no center outward protrusion and no connecting outward protrusions. In some embodiments, two sides and two ends of the interlocking block molds have no center outward protrusion and no connecting outward protrusions. In some embodiments, three sides and one end of the interlocking block molds have no center outward protrusion and no connecting outward protrusions.

The center outward protrusions allow materials to pass through connected interlocking block molds in different directions, with the number of possible directions depending on the number of sides of that an interlocking block mold has. The center outward protrusions also allow interlocking block molds to be filled with material. For example, multiple interlocking block molds could be connected together and then filled with sand, cement, mud, rocks, gravel, water, insulation, gas, fluid, flotation materials, etc.

In some embodiments, the surfaces of the sides of an interlocking block mold are flat. In some embodiments, the surfaces of the sides of an interlocking block mold are smooth. In other embodiments, one or more surfaces of an interlocking block mold are rough. In further embodiments, one or more surfaces of an interlocking block mold comprises a non-slip coating, bumps, ridges, or grooves.

The interlocking block molds can be made of any suitable material, depending on the application of the block molds and the structure being constructed. Strong, consistent materials with a high load carrying ability and resistant to stresses can be used to make the interlocking block molds. In some embodiments, the interlocking block molds comprise 6061 aluminum. In certain embodiments, the interlocking block molds comprise 7050 aluminum. In some embodiments, the interlocking block molds comprise cement. In certain embodiments, the interlocking block molds comprise hydraulic cement. In further embodiments, the interlocking block molds comprise cementitious materials. In some embodiments, the interlocking block molds comprise glass. In other embodiments, the interlocking block molds comprise plastic. In certain embodiments, the interlocking block molds comprise high density polyethylene (HDPE or No. 2 plastic). In still further embodiments, the interlocking block molds comprise clear plastic. In additional embodiments, the interlocking block molds comprise silicone. In additional embodiments, the interlocking block molds comprise polyvinyl chloride. In further embodiments, the interlocking block molds comprise metal or alloy. In certain embodiments, the interlocking block molds comprise aluminum, copper, brass, or stainless steel. In additional embodiments, the interlocking block molds comprise wood and/or wood products. In some embodiments, the interlocking block molds comprise cloth. In further embodiments, the interlocking block molds comprise insulation. In some embodiments, the interlocking block molds comprise rubber. In some embodiments, the interlocking block molds comprise flexible rubber. In some embodiments, the interlocking block molds comprise nitrile. In some embodiments, the interlocking block molds comprise sponge. In some embodiments, the interlocking block molds comprise ceramic. In some embodiments, walls or floors or other structures constructed with interlocking block molds comprising the interlocking block molds are made of a material and filled with another material. The walls or floors or structures comprising the interlocking block molds may be filled with air, floatable foam, insulation, or a cementitious material, or another material. In further embodiments, the interlocking block molds comprise a combination of materials described herein.

The sides of the interlocking block molds can be thick or thin depending on the application of the block molds and the structure being manufactured or built. In some embodiments, the sides are thin. In other embodiments, the sides are thick. In further embodiments, the sides have a thickness ranging from about 3 mils to about 12″. In some embodiment, the sides comprise an inner wall and an outer wall. In some embodiments, the sides comprise an inner wall and an outer wall and are hollow in between the inner wall and outer wall. In further embodiments, the sides are filled with a material between the inner wall and outer wall. In still other embodiments, the blocks manufactured with interlocking block molds are partially hollow, so that the only unfilled part of the blocks are the connecting outward protrusions, edge outward protrusions, center outward protrusions, and center hollowed area of the block mold from which all exterior protrusions project from therein.

The interlocking block molds can have a variety of sizes. In some embodiments, the block molds have edges that are uniform length. In other embodiments, the block molds have one length on the edges of the ends and a different length along the edges of the parallelogram that are not part of the end. In some embodiments, the block molds range in size from about 1 foot to about 20 feet.

In other embodiments, the block molds range in size from about 1 foot to about 15 feet. In further embodiments, the block molds range in size from about 1 foot to about 10 feet. In still further embodiments, the block molds range in size from about 1 foot to about 8 feet. In other embodiments, the block molds range in size from about 1 foot to about 6 feet. In some embodiments, the block molds range in size from about 1 foot to about 4 feet. In some embodiments, the block molds range in size from about 1 foot to about 3 feet.

In some embodiments, the interlocking block molds range in size from about 1 inch to about 48 inches. In further embodiments, the interlocking block molds range in size from about 1 inch to about 36 inches. In still further embodiments, the interlocking block molds range in size from about 1 inch to about 24 inches. In particular embodiments, the interlocking block molds range in size from about 1 inch to about 12 inches. In still particular embodiments, the interlocking block molds range in size from about 250 mils to about 1 inch.

In some embodiments, the edges of the block molds are about 1 foot long. In some embodiments, the edges of the block molds are between about 1 and about 2 feet long, inclusive. In further embodiments, the edges of the block molds are between about 2 and about 3 feet long, inclusive. In still further embodiments, the edges of the block molds are between about 3 and about 4 feet long, inclusive. In yet further embodiments, the edges of the block molds are between about 4 and about 5 feet long, inclusive. In certain embodiments, the edges of the block molds are between about 5 and about 6 feet long, inclusive.

In some embodiments, the edges of the end of a block mold range in size from about 1 inch to about 10 feet and the edges of the sides of the block molds range in size from about 1 inch to about 10 feet.

In some embodiments, a block mold further comprises a faceplate attached to a side of the block mold. A faceplate is designed to cover the center outward protrusion, connecting outward protrusions, edge outward protrusions, or some combination of center outward protrusion, connecting outward protrusions, and/or edge outward protrusions. When a faceplate is attached to a side, fortifying material does not pass through the outward protrusions on that side. When a structure is created from interlocked block molds, faceplates can be attached to a plurality of sides of the interlocking block molds prior to filling the space between the interlocking block molds and the faceplates with a fortifying material. The faceplates allow for fortifying material to flow in a desired pattern.

In some embodiments, a plurality of faceplates are attached to a block mold or attached to a plurality of interlocked block molds. For example, when a wall is created from interlocked block molds, faceplates can be attached to one or more sides of the wall. Then, fortifying material can be poured into the wall comprised of interlocked block molds. The fortifying material will flow outside of the center area of the block mold space from which all exterior protrusions project from therein and outside of the center outward protrusions of the interlocked block molds, but the faceplates will prevent the fortifying material from flowing in undesired directions.

Faceplates can be made of the same material as the interlocking block molds to which it attaches or a different material. In various embodiments, faceplates comprise wood, plastic, HDPE, PVC, rubber, nitrile, glass, metal, metal alloy, aluminum, brass, copper, stainless steel, cloth, cementitious materials, ceramic, gasket material, silicone, or combinations thereof.

In some embodiments, the faceplates are adorned with designs or pictures to create an aesthetically pleasing appearance when attached to interlocked block molds. In certain embodiments, a plurality of faceplates makes up a large design. For example, a large design can be an image of nature, or a city, or a sequence, or an underwater scene, etc. In other embodiments, each faceplate has its own picture, painting, image, or design on it.

Methods of Connecting Interlocking Block Molds

This disclosure also provides methods of connecting interlocking block molds. The interlocking block molds of this disclosure are designed to be connected or interlocked. The block molds can be connected on any of the sides or ends.

This disclosure provides methods for connecting interlocking block molds with hardware. In an embodiment of the method, at least one first connecting outward protrusion of a first side of a first interlocking block mold is aligned with at least one second connecting outward protrusion of a second side of a second interlocking block mold. In some embodiments, the first side of the first interlocking block mold comprises a first center outward protrusion and the second side of the second interlocking block mold comprises a second center outward protrusion, and, during the aligning, the first center outward protrusion of the first interlocking block mold is aligned with the second center outward protrusion of the second interlocking block mold. At least one first connecting outward protrusion of the first side of the first interlocking block mold is connected to the least one second connecting outward protrusion of the second side of the second interlocking block mold with hardware.

This disclosure provides methods for connecting interlocking block molds with connection couplings. In an embodiment of the method, at least one first connecting outward protrusion of a first side of a first interlocking block mold is aligned with at least one second connecting outward protrusion of a second side of a second interlocking block mold. In some embodiments, the first side of the first interlocking block mold comprises a first center outward protrusion and the second side of the second interlocking block mold comprises a second center outward protrusion, and, during the aligning, the first center outward protrusion of the first interlocking block mold is aligned with the second center outward protrusion of the second interlocking block mold. At least one first connecting outward protrusion of the first side of the first interlocking block mold is connected to the least one second connecting outward protrusion of the second side of the second interlocking block mold with connection couplings.

Any suitable connecting hardware or connecting couplings can be used. The disclosure provides numerous types of hardware that can be used. However, the embodiments provided in the disclosure are not meant to be exhaustive of all possible types of hardware that can be used. In some embodiments, the hardware comprises a screw. In some embodiments, the hardware comprises a nail. In some embodiments, the hardware comprises a bolt and a nut. In other embodiments, the hardware comprises threaded rod and a nut. In still other embodiments, the hardware comprises a washer. In further embodiments, the hardware comprises locking inserts which can be inserted into the at least one first connecting outward protrusion of the first side of the first interlocking block molds and into the least one second connecting outward protrusion of the second side of the second interlocking block molds, thereby connecting the two interlocking block molds. In still further embodiments, the hardware comprises mechanical fasteners. In additional embodiments, the hardware comprises grommets. In other embodiments, the hardware comprises inserts, latches, pins, retaining clips, rivets, rivet nuts, socket products, springs, toggle bolts, expandable foam inserts, expandable anchors, concrete anchors, plastic hardware, nuts, washers, and bolts. In some embodiments, the hardware is a combination of any of the hardware described herein, or other suitable hardware.

In some embodiments, the method comprises connecting a plurality of the first connecting outward protrusions of the first side of the first interlocking block molds to a plurality of the second connecting outward protrusions of the second side of the second interlocking block molds. In certain embodiments, the method comprises connecting all of the first connecting outward protrusions of the first side of the first interlocking block molds to all of the second connecting outward protrusions of the second side of the second interlocking block molds. In further embodiments, the method comprises connecting at least one third connecting outward protrusion of a third side of the first interlocking block molds with at least one fourth connecting outward protrusion of a fourth side of a third interlocking block molds.

In some embodiments, the method comprises connecting two interlocking block molds together. In some embodiments, the method comprises connecting more than two interlocking block molds together. In additional embodiments, the method comprises connecting a plurality of block molds in different directions. In further embodiments, the method comprises connecting more than two interlocking block molds together to build a structure. In some embodiments, the structure is a wall, a floor, a foundation, or a building. In other embodiments, the structure is a floatable raft. In further embodiments, the structure is a garden. In still further embodiments, the structure is an artificial reef.

In some embodiments, additional materials are used when connecting the interlocking block molds. In some embodiments, gaskets are placed between connected interlocking block molds. In some embodiments, fusible links and/or a sealant are placed between connected interlocking block molds to strengthen the bond between the block molds.

In some embodiments, the interlocking block molds are aligned and fused together by causing plastic coatings on each block to melt and fuse together. In other embodiments, the interlocking block molds can be aligned and glued together. In still other embodiments, the interlocking block molds can be welded or brazed together. In some embodiments, the interlocking block molds are connected together without hardware, but with connector couplings connecting the outward protrusions of the interlocking block molds. A person of ordinary skill in the art can envision additional ways to connect the interlocking block molds of this disclosure. Such connection methods are envisioned within the scope of this disclosure.

In some embodiments, the method further comprises connecting one or more faceplates to one or more sides of an interlocking block mold or to one or more side of one or more interlocked block molds. In such methods, the faceplate is aligned with a side of an interlocking block mold. Then, the faceplate is attached to the center outward protrusion, connecting outward protrusions, edge outward protrusions, or a combination thereof, of the side with hardware.

In further embodiments, the method comprises filling the exterior of the structure comprising interlocking block molds with a fortifying material. In some embodiments, the fortifying material is insulation, foam, sand, water, gravel, rocks, cementitious material, metal reinforcements, or a combination thereof. In some embodiments, the fortifying material is poured, pumped, or otherwise added to flow through the exterior structure of the interlocked block molds.

Manufacturing of Interlocking Block Molds

The interlocking block molds can be made through a variety of methods depending on the materials used to make the block molds. In some embodiments, the interlocking block molds are cast poured. In other embodiments, the interlocking block molds are made from one uniform piece. In some embodiments, the interlocking block molds are made from a mold. In some embodiments, particularly where the interlocking block molds comprise plastic, the interlocking block molds are manufactured by rotomolding, rotational molding, injection molding, plastic extrusion molding, blow molding, vacuum molding, or by other suitable molding methods. In further embodiments, the interlocking block molds are constructed from two or more separately constructed components and then joined together. In some embodiments, particularly when the interlocking block molds comprise metal, the interlocking block molds are made by bolting the sides together, or welding sides together, or brazing sides together, or machining, casting, forming, joining, or assembling. In additional embodiments, particularly when the interlocking block molds comprise wood, the interlocking block molds are made by being machined, assembled, glued together, cast molded, or as an engineered wood product. In further embodiments, the interlocking block molds are produced by 3D printing or additive manufacturing, or any process in which material or materials are joined or solidified under computer control to create a threedimensional object. In some embodiments, rapid prototyping is used to produce the interlocking block molds.

In some embodiments, the block molds are made as solid pieces and then desired center outward protrusions, connecting outward protrusions, or edge outward protrusions are drilled and milled, and the interior space is hollowed out for mechanical hardware to be used to pass through the connecting outward protrusions, or edge outward protrusions. For example, in some embodiments, a solid prism is manufactured and then each side is drilled and milled with the desired configuration of outward protrusion locations and then a drill cutting wheel enters into side center protrusion locations and hollows out the interior portion of the block.

### EXAMPLES

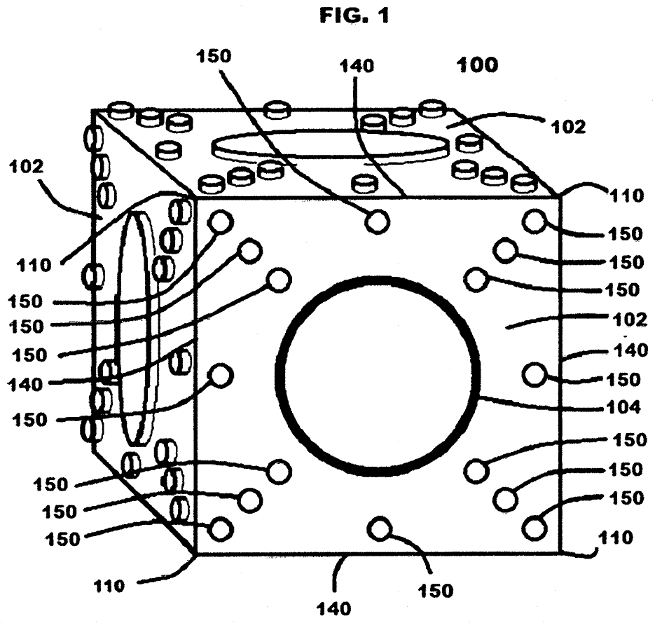

One embodiment of a rectangular interlocking block mold is shown in FIG. 1. Interlocking block mold 100 has six sides. Sides 102 are shown in FIG. 1. Sides 102 comprises center outward protrusions 104 around the center of sides 102. Although center outward protrusions 104 is circular in FIG. 1, the center outward protrusions need not be circular. Sides 102 also comprises corners 110. Connecting outward protrusions 150 are proximate to corner 110.

Side 102 also comprises edges 140. Edge outward protrusions 160 are proximate to the middle of edges 140.

Sides 102 all have the same configuration. The sides of block mold 100 that are not shown could also have the same configuration.

A plurality of interlocking block molds 100 can be aligned and connected together by hardware through the connecting outward protrusions and the edge outward protrusions. Interlocking block molds can be connected to all six sides of block 100. Once connected, materials, such as pipe, wires, conduit, and rebar, can also be passed through connected center outward protrusions. In some structures, faceplates can be connected to any number of sides. Once faceplates are connected, the structure between the exterior of the mold and the faceplates can be filled with any desirable material, such as sand, foam, water, gravel, rocks, or cement.

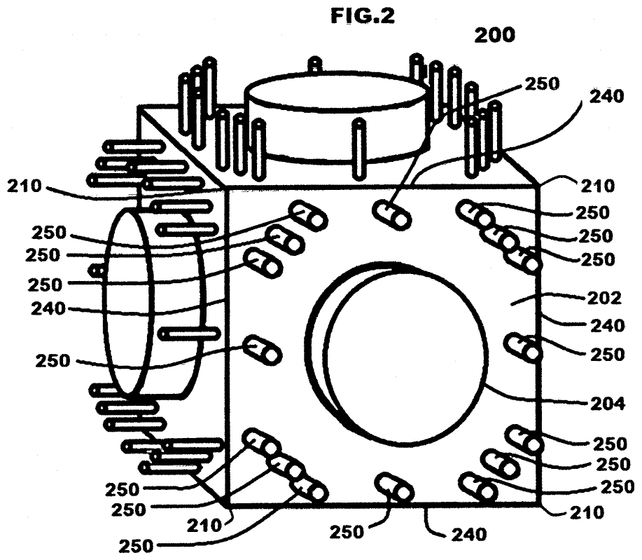

Referring now to FIG. 2, block 200 illustrates another embodiment of the interlocking block molds disclosed herein. Block 200 has connecting outward protrusions and edge outward protrusions in a different orientation than in block mold 100. Connecting outward protrusions 250 are proximate to corner 210 on side 202 but arranged in a different orientation than the connecting outward protrusions on block 100. This is illustrated by all the connecting outward protrusions 250 proximate to corners 210.

Edge outward protrusions 260 are proximate to the middle of edges 240. However, edge outward protrusions 250 are further from edges 240 and slightly closer to center outward protrusion 204 in block 200 than their counterparts in block mold 100. As illustrated by way of example in FIGS. 1 and 2, the configuration of outward protrusions on the interlocking block mold of this disclosure can vary. Different configurations of connecting outward protrusions, center outward protrusions, and edge outward protrusions may be desired depending on the application of the interlocking block molds.

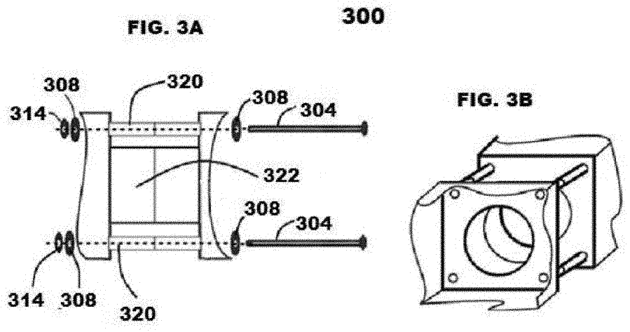

Referring now to FIG. 3A and how it is related to FIG. 3B. FIG. 3A and FIG. 3B have the same two interlocking block mold patterns, although FIG. 3B does not show any mechanical hardware, FIG. 3B does show a better view of the center outward protrusions 322 and the four connecting outward protrusions 320 of each interlocking block mold.

The interlocking block molds of this disclosure can be connected together with mechanical hardware, bolts 304, nuts 314, and washers 308. The center outward protrusions 322 of all six sides of each of the two perfectly aligned interlocking block molds of FIG. 3A (partially shown) have an area around its circumference large enough for the average sized human hands and arms to reach into the hollow portion of the inside of the interlocking block mold. Human hands will reach into the center outward protrusions 322 of each of the aligned interlocking block molds OF FIG. 3A, along with passing the necessary bolts 304, washers 308, and nuts 314 from outside of the interlocking block molds to inside of the hollow portion of the interlocking block molds.

In FIG. 3A, the division of the two separate interlocking block molds, where the two block molds come into contact with each other is located where the center outward protrusions 322 come into contact with each other, at the same time as the connecting outward protrusions 320 come into contact with each other. In FIG. 3A, The center outward protrusion has a large enough area around its circumference to allow the hands and arms of an average sized adult to pass the mechanical hardware through the center outward protrusions and maneuver the bolts through the nuts to pass through the connecting outward protrusions of both of the interlocking block molds to be connected. Although there may be special tools required for other configurations of interlocking block molds with different dimensions, the interior hollow portions of the interlocking block molds of FIG. 3A are able to be accessed by human hands to make the mechanical connections of the nuts with the bolts and the washers. The washers used are to enable the connection to be more secure, as both interlocking block molds are secured together, where two aligned connecting outward protrusions become aligned, as the corners of the interlocking block molds become aligned, and by passing through the threaded end of the bolt 304, through washer 308, then begins passing through the connecting outward protrusion 320 of the interlocking block mold of the first block mold. The threaded end of bolt 304 continues through the connecting outward protrusion 320 of the first interlocking block mold, then the bolt 304 begins passing through the connecting outward protrusion 320 of the second block mold. As bolt 304 continues through the connecting outward protrusion of the second block mold, it makes it through to the hollow interior section of the second interlocking block mold. Bolt 304 is passed through washer 308 where it soon comes into contact with nut 314, which is a nut with the same thread pattern as the bolt. Nuts 314 will wind onto the threaded bolts 304, and the washers 308 will help promote a secure connection. All connections in

FIG. 3A will be of the same procedure as depicted above.

FIG. 3B shows a cutout view of two aligned interlocking block molds without hardware.

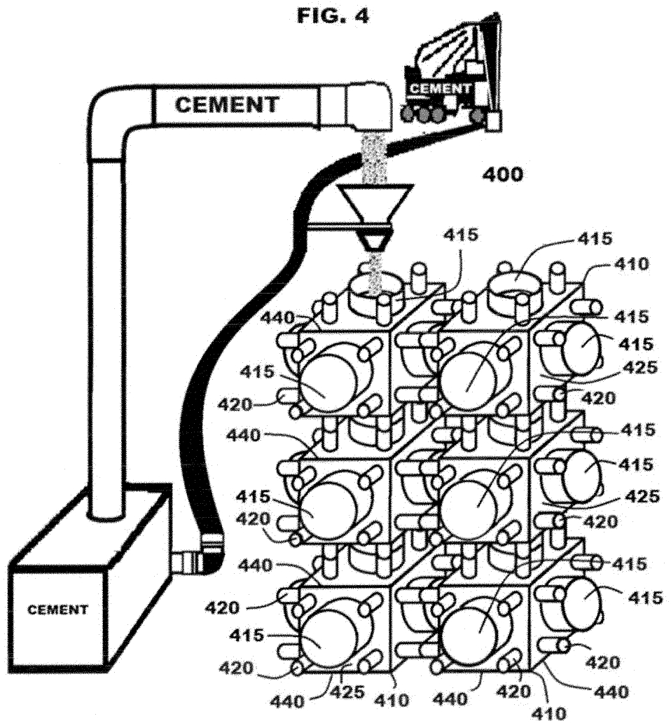

FIG. 4 shows six interlocking block molds connected together in an exemplary configuration being filled with cement. To keep the desired cement within the mold configuration, all outward protrusions below the top corner 410 have a solid membrane on each and every exterior end of the outward protrusions, including the center outward protrusions 410 and connecting outward protrusions 420. The outward protrusions above the upper most corner 410 do not have solid membranes, so as to allow the cement being administered by the cement truck pumping the cement through a hose to a cement rectangular tank, to be further pumped up a pipe stack to the point of discharge, where a cement mix pours into the six interlocking block molds connected together through a side center outward protrusion 415, as illustrated in FIG. 4. FIG. 4 shows six interlocking block molds, whereas the bottom two interlocking block molds have neither side outward protrusions nor connecting outward protrusions.

The cement will fill the six connected interlocking block molds connected together in an exemplary configuration from the bottom to the top, from the two bottom sides 425 (not shown), filling the corners 410 and edges 440 at the base of this configuration of six interlocking block molds, filling every center outward protrusion 415 and every connecting outward protrusion 420, and further filling all the corners 420 and around every edge 440, until all of the corners 410, edges 440, center outward protrusions 415, and connecting outward protrusions 420 have been completely filled with cement to the flood level rims of the upper most center outward protrusions and connecting outward protrusions.

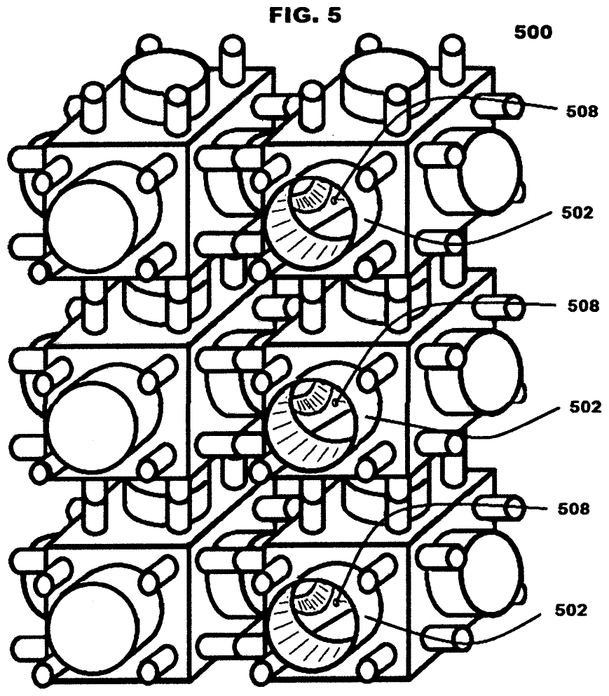

FIG. 5 shows six interlocking block molds connected together in an exemplary configuration. Hardware 508 connecting the six interlocking block molds together is shown through center outward protrusions 502.

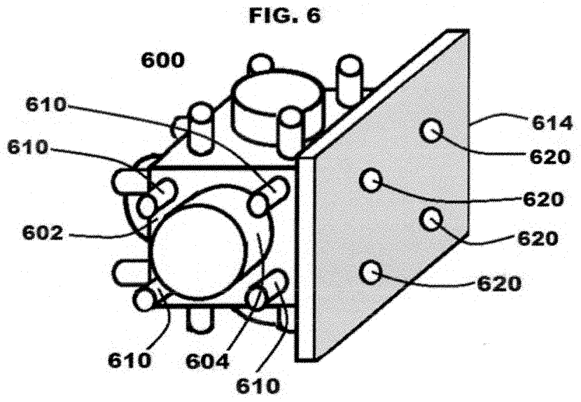

In some embodiments, one or more sides of an interlocking block mold can be covered with a faceplate. FIG. 6 shows an interlocking block mold with a faceplate covering one side of the interlocking block mold. Interlocking block mold 600 comprises six sides. Each side of interlocking block mold 600 has a center outward protrusion and four connecting outward protrusions. Side 602 comprises center outward protrusion 604 and connecting outward protrusions 610. Faceplate 614 is attached to one side of interlocking block mold 600. Faceplate 614 blocks the center outward protrusion of the side of interlocking block mold 600 to which faceplate 614 is connected (center outward protrusion obscured by faceplate 614 in FIG. 6). Faceplate 614 comprises faceplate connections 620 for connecting faceplate 614 to the connecting outward protrusions (not shown in FIG. 6) of the side of interlocking block mold 600. One or more faceplates can be connected to one or more sides of an interlocking block mold, depending on the application of the interlocking block mold.

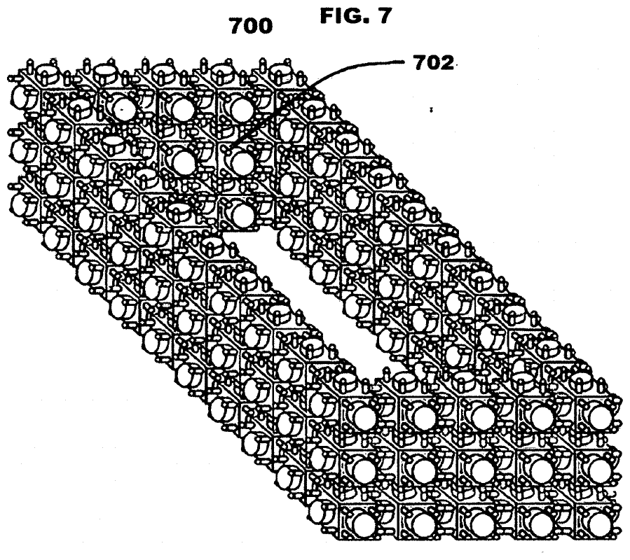

FIG. 7 shows a plurality of interlocking block molds connected together in an exemplary configuration. Structure 700 is three block molds high by five block molds wide by ten block molds long and includes cavity 702. Structure 700 can be a foundation or enclosure or a variety of other structures depending on the size of the interlocking block molds and the desired use.

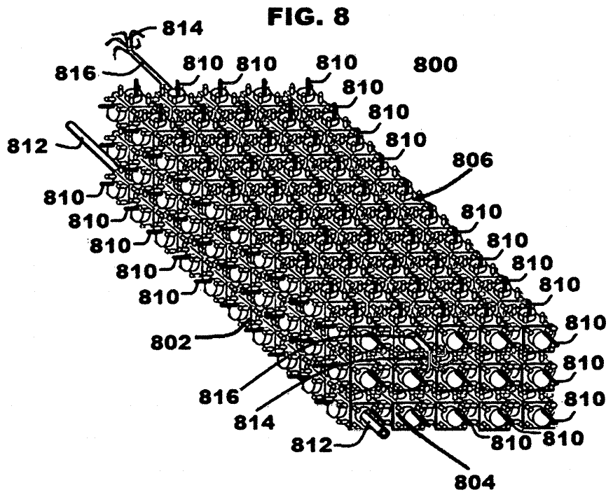

FIG. 8 shows a plurality of interlocking block molds connected together in another exemplary configuration that have materials such as rebar, pipes, wire, and conduit passing through the series of connected interlocking block molds, in different directions. Structure 800 does not comprise a cavity and is a solid prism comprised of interlocked block molds. Like structure 700, structure 800 is three block molds high by five block molds wide by ten block molds long. Structure 800 can also be a foundation, although, unlike structure 700, likely could not be used as an enclosure given the lack of cavity. Depending on the size of interlocking block molds in structure 800, structure 800 could be used as a wall.

Referring now to FIG. 8, After properly terminating the materials such as rebar 810, pipes 812, wire 814, and conduit 816 passing through the series of connected interlocking block molds, in different directions, faceplates can be attached to the interlocking block molds of sides 802, and 804. Then, fortifying material can be poured throughout the exterior of the outward protrusions of the interlocking block molds of side 806.

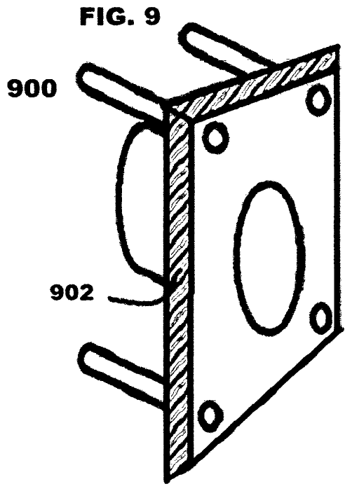

FIG. 9A shows as perspective of side removed from an interlocking block mold (not shown). Sidewall 902 can have a variety of thickness depending on the size, material, and use of the interlocking block mold. Sidewall 902 is solid. However, the walls of interlocking block mold can comprise two or more walls, or have the exterior of the block mold filled with a material, such as insulation, gas, liquid, foam, cement, rocks, gravel, or a combination thereof.

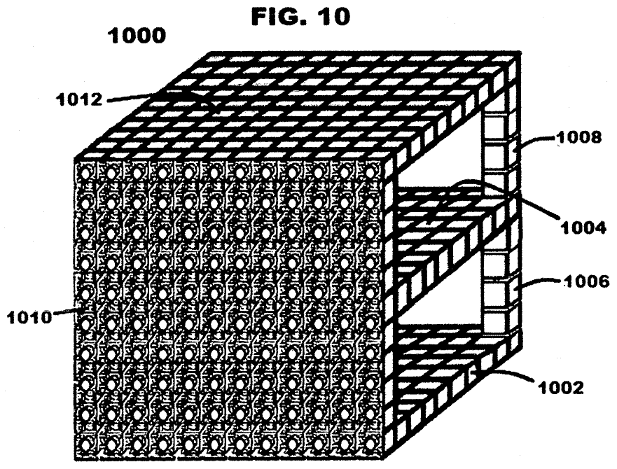

Referring now to FIG. 10, structure 1000 represents a building structure comprised of interlocking block molds. Structure 1000 comprises floors 1002 and 1004 and posts 1006 and 1008 comprised of interlocking block molds with faceplates attached. Structure 1000 also comprises wall 1010 constructed entirely of exposed interlocking block molds, and top level 1012 comprised of interlocking block molds with faceplates. Depending on the size of the interlocking block molds, structure 1000 can be a large building, such as for human habitation, or a smaller building, such as a utility shed. Structure 1000 illustrates just one of many different possible structures.

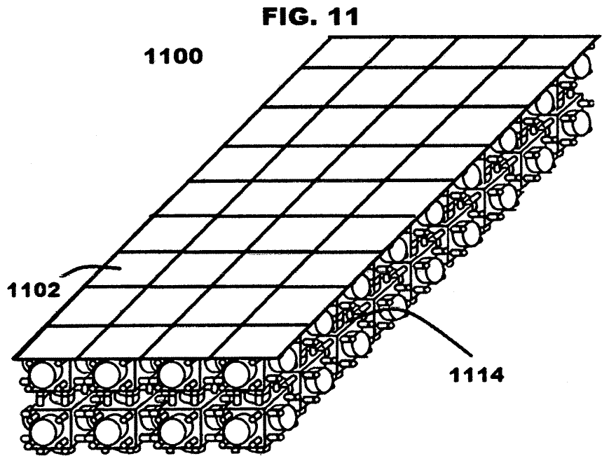

FIG. 11 shows structure 1100 comprising 72 interlocking block molds connected mechanically. Faceplates are connected to each interlocking block molds of top side

1102.

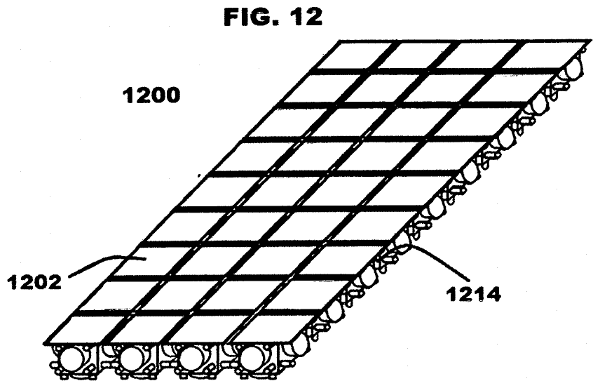

FIG. 12 shows structure 1200 comprising 36 interlocking block molds connected mechanically. Faceplates are connected to each interlocking block molds of top side 1202.

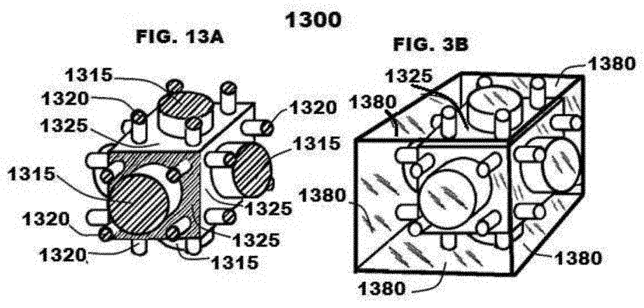

FIG. 13A is a preferred example of a rectangular interlocking block mold. FIG. 13A is a rectangular prism having six sides. Top side 1325 comprises corners 1305. Top side 1325 also comprises center outward protrusion 1315 and connecting outward protrusions 1320 proximate to corners 1305. Each of the sides 1325 have the same configuration of center outward protrusions, corners, and connecting outward protrusions proximate to the corners.

FIG. 13B shows a rectangular prism of six sides, with five sides comprised of a solid transparent material, including the bottom side comprising the bottom side and a solid transparent material comprising each of the four sides of the rectangular prism. The sixth side is the top of the rectangular prism in FIG. 13B, having a flood level rim comprised of the transparent materials of the sides of the rectangular prism of FIG. 13B, and is open to the air, allowing the interlocking block mold of FIG. 13A to bel placed inside the transparent box for manufacturing an interlocking block.

Retaining Wall and Seawall

In some embodiments, the interlocking prism block molds of this disclosure are designed to form a seawall or retaining wall. The outward protrusions of each interlocking block mold when connected together with other interlocking block molds of the same configuration create spaces between the faces of the interlocking block molds for earth, indigenous vegetation, and/or faceplates, to strengthen the shorelines from erosion. In such embodiments, a plurality of interlocking prism block molds are interlocked together to form the desired wall of any desired configuration. In certain embodiments, the wall can be made vertical. In other embodiments, the wall is a gravity wall, piling wall, cantilever wall, or an anchored wall. In other embodiments, the interlocking block molds are arranged to create walls with angles or corners or curved. In still other embodiments, a wall comprising interlocking block molds is built at an incline. In some embodiments, the tops and bottoms of the interlocking block molds comprise protrusions and corresponding indentations to receive the protrusions to allow the block molds to connect at an offset to create an incline. In other embodiments, the shape of the interlocking block molds enables an incline to be created.

Then, faceplates are attached to the outward protrusions of each block mold on either side of the wall. The faceplates are secured in place so that the interiors of the block molds and/or the interiors between the faceplates and the exterior of the interlocking block molds can be filled with a desired material. In some embodiments, interiors of the block molds and/or the interiors between the faceplates and the exterior of the interlocking block molds wall is filled with sand. In some embodiments, interiors of the block molds and/or the interiors between the faceplates and the exterior of the interlocking block molds wall is filled with cement. In other embodiments, the interiors of the block molds and/or the interiors between the faceplates and the exterior of the interlocking block molds wall is filled with rocks or gravel. In further embodiments, the interiors of the block molds and/or the interiors between the faceplates and the exterior of the interlocking block molds wall is filled with a material of sufficient mass or strength to retain whatever the retaining wall is designed to retain.

Sea walls made from interlocking block molds promote vegetation and earth to collect within the connected outward protrusions of each block mold, as they are connected together with other block molds. Two, sea walls made from interlocking block molds with face plates are stronger than sand bags due to the block molds being mechanically connected. Three, the sea wall made of interlocking block molds with face plates attached to the block molds can be filled with a fortifying material such as cement or sand, thereby increasing the strength of the sea wall. Furthermore, in some embodiments, the interlocking block molds are made of plastic with cloth material face plates. Such interlocking block molds can be interlocked and filled with sand between the exterior of the block mold and the interior of the attached faceplates to provide a superior sand bag-like structure with mechanically connected block molds.

Interlocking block molds intended to be used to create a sea wall can be made of noncorroding materials in order to withstand the corrosive nature of the sea.

### Foundation and Structures

In other embodiments, the interlocking block molds of this disclosure are designed to form a foundation for a building or other structure. In such embodiments, a plurality of interlocking block molds are connected in horizontal and vertical fashion according to a design for a foundation. The foundation can have any suitable shape depending on the structure being built. In some embodiments, the connected interlocking block molds form the foundation with material poured into the structure around the exterior portions of the block molds. In other embodiments, once the requisite number of interlocking block molds are connected, faceplates can be added to the interior face and exterior face of the wall created by the interlocked block molds. Then, a fortifying material can be poured into the interlocked block mold structure, thereby creating a foundation. Additional structures can be built on top of the foundation.

In other embodiments, the interlocking block molds of this disclosure are designed to build a structure. The structure could be a residential building, a commercial building, an office building, sports arena, or any building. In some embodiments, the building is a small building such as a garage or shed. In other embodiments, the building is a residential building such as a house. In further embodiments, the building is a large building. The size of the interlocking block molds used in buildings can vary depending on the size of the building being constructed.

Flotation

In another embodiment, the interlocking prism molds with exterior protrusions of this disclosure are comprised of a buoyant material. In such embodiments, a plurality of interlocking prism molds can be interlocked together to create a flotation device. In such embodiments, a plurality of block molds are interlocked together. Then, in some embodiments, faceplates are attached to the sides of the flotation device that will face the water, thereby preventing water from coming into the flotation device.

The flotation devices comprised of interlocking block molds can vary in size. In some embodiments, the flotation device is a raft designed to hold one or more people.

### EQUIVALENTS

Those skilled in the art will recognize, or be able to ascertain, using no more than routine experimentation, numerous equivalents to the specific embodiments described specifically in this disclosure. Such equivalents are intended to be encompassed in the scope of this disclosure and the following claims.

1. An interlocking block mold, comprising at least three parallelogram sides, wherein each parallelogram side comprises a side center outward protrusion around the center of the parallelogram side, four side corners, at least one side interlocking outward protrusion proximate to each side corner; and two ends.

2. The interlocking blocks mold of claim 1, further comprising a plurality of side interlocking outward protrusions proximate to each side corner.

3. The interlocking blocks mold of claim 1, wherein each side further comprises four side edges and one or more side edge outward protrusions proximate to one or more of the side edges.

4. The interlocking blocks mold of claim 1, further comprising at least one faceplate.

5. The interlocking blocks mold of claim 3, wherein the at least one faceplate is connected to one side center outward protrusion of one side.

6. The interlocking blocks mold of claim 1, wherein each end comprises an end center outward protrusion around the center of the end, at least three end corners, and at least one end interlocking outward protrusion proximate to at least one end corner.

7. A method of connecting a first interlocking blocks mold and a second interlocking blocks mold, comprising providing a first interlocking blocks mold comprising:
a first side comprising: a first side center outward protrusion around the center of the first side,
four first side corners, four first side interlocking outward protrusions, each first side interlocking outward protrusion
being proximate to a first side corner,
providing a second interlocking blocks mold
comprising: a second side comprising: a
second side center outward protrusion around
the center of the second side
four second side corners,
four second side interlocking outward protrusions, each second side interlocking
outward protrusion being proximate to a second side corner; aligning the four first side interlocking outward protrusions with the four second side outward protrusions; inserting hardware through at least one aligned first side interlocking outward protrusion and a second side interlocking outward protrusion, thereby connecting the first interlocking blocks mold and the second interlocking blocks mold.

8. The method of claim 7, wherein the hardware is selected from the group consisting of a bolt, a screw, a nut, threaded rod, a plastic insert, and a washer.

9. The method of claim 7, wherein the first interlocking blocks mold comprises a third side, the method further comprising attaching a faceplate to the third side.

10. The method of claim 7, wherein the first side comprises first four edges and one or more first edge outward protrusions located proximate to one or more of the first four edges, and wherein the second side comprises second four edges and one or more second edge outward protrusions located proximate to one or more of the second four edges, the method further comprising inserting hardware through one or more first edge outward protrusions and one or more second edge outward protrusions.

11. The method of claim 7, wherein a connecting coupling is selected from the group consisting plastic or PVC couplings, rubber couplings with tightening bands, couplings that mount to the exterior of the connecting outward protrusions and fasten through the couplings and become affixed to or through the exterior wall of the outward exterior protrusions.

12. The interlocking blocks mold structure of claim 13, further comprising one or more pipes within the center outward protrusions of two or more interlocking blocks molds.

13. The interlocking blocks mold structure of claim 13, further comprising one or more wires within the center outward protrusions of two or more interlocking blocks molds.

14. The interlocking blocks mold structure of claim 13, further comprising conduit within the center outward protrusions of two or more interlocking blocks molds.

15. The interlocking blocks mold structure of claim 13, wherein the structure is filled with a material or a combination of materials.

16. The interlocking blocks mold structure of claim 15, wherein the material is selected from the group consisting of plastic, sand, cement, water, gravel, metal, rock, insulation, or a combination thereof.

17. The interlocking blocks mold structure of claim 13, wherein the structure is a mold for manufacturing interlocking blocks, wall, foundation, garden, artificial coral reef, or flotation device.

18. A method of manufacturing an interlocking block by using the interlocking block mold claim 1, whereas the interlocking block mold is secured into a container of proper dimensions to snuggly fit the interlocking block mold, as the exterior ends of the outward protrusions slide against the inside walls of the container, until the outward protrusions at the bottom of the interlocking block mold come into complete contact with the inside bottom of the container to which the interlocking block mold has been placed into. The exterior ends on the top of the interlocking block mold should be flush and on the same plane, at the flood level rim of the edges around the top perimeter of the container to which the interlocking block mold has been placed into. Depending on the structural integrity of the material used for manufacturing the interlocking block mold will depend on the measures that need to be taken to ensure the center outward protrusions and the connecting outward protrusions to not shift out of place during the administering of the materials to encompass the entire area of the container, from the exterior walls of the interlocking block mold to the interior walls of the container, and to the top of the flood level rim of the container from where the interlocking block mold has been placed. The measurements, from end to end of each side of the interlocking block mold have been predetermined and measured for accuracy. The measurements of the interlocking block mold include, but are not limited to, measuring the distance between the center of the interlocking block mold to the furthest end of each center outward protrusion and each connecting outward protrusion, to determine the measurements of the inside structure of the container to which the interlocking block mold will be placed. When placing the interlocking block mold into the container being used for allowing the materials to encompass the entire area of the container, except for the inside structure of the interlocking block mold, to which the ends of each center outward protrusion and each connecting outward protrusion have been closed off, by design, to enable the entire inside of the interlocking block mold to be airtight, and not allow any undesired materials to the inside of the interlocking block mold structure. The exterior ends of the center outward protrusions from the center of the interlocking block mold to the inside walls of the container will reflect the dimensions of the exterior interlocking block to be manufactured by this method. While placing the interlocking block mold into the container, the center outward protrusions and connecting outward protrusions have been pre-sealed and also become in contact with the interior portion of the container which will host the interlocking block mold and allow the desired materials to surround the exterior walls of the interlocking block mold and encompass the entire area of the box except for the interior structure of the interlocking block mold. After the completion of the curing time of the materials used to fill the entire area to which the interlocking block mold has been placed, the material(s) used to block the ends of the center outward protrusions and the connecting outward protrusions may be removed.
